(19) United States
(12) Patent Application Publication
(10) Pub. No.: US 2005/0149988 A1
(43) Pub. Date: Jul. 7, 2005

(54) Delivering interactive television components in real time for live broadcast events

(75) Inventor: Michael F. Grannan, Austin, TX (US)

Correspondence Address: TOLER & LARSON & ABEL L.L.P., 5000 PLAZA ON THE LAKE STE 265, AUSTIN, TX, 78746, US

(73) Assignee: SBC Knowledge Ventures, L.P.

(21) Appl. No.: 10/752,301

(22) Filed: Jan. 6, 2004

(51) Int. Cl. H04N 7/025; H04N 7/10; H04N 7/16

(52) U.S. Cl. 725/136

(57) ABSTRACT

Interactive content creation software tools are provided to interactive content authors via the Internet. Interactive content programs associated with video of a live event and created by the interactive content authors using the interactive content creation software tools are received via the Internet. The video of the live event and its associated interactive content programs associated therewith are broadcast to end viewers via a video distribution network. Each of the end viewers is provided a list of the interactive content programs associated with the video so that each end viewer can independently select one of the interactive content programs from the list for display with the video.

### FIELD OF THE INVENTION

The present invention relates to interactive television methods and systems.

### DESCRIPTION OF THE RELATED ART

Interactive television (ITV) is a process of including components along with a television broadcast that permits a viewer to receive additional data content and interact with the television program. In practice, interactivity components are embedded in the vertical blanking interval for extraction at the viewers' set-top boxes.

Examples of ITV include playing along with a game show, or clicking on an item of interest shown on a television program and being led to an option to purchase the item. ITV typically provides features beyond Internet access through a television, which focuses on Internet-like services such as instant messaging, chat and current weather.

Although the introduction of interactive content is desirable to both television show producers and its viewers, ITV has had limited success in North America, hindered by both the limited number of ITV set-top boxes deployed and the dearth of ITV content available.

Currently, a television show's producer controls the development of any accompanying interactive programming. Typically, the producer plans the interactive programming during the production of the show since interactive content design often is as time consuming as building a complex Web site. Thus, the development of the interactivity is done in advance of the actual air date of the show.

Tools for building ITV content are migrating to more fully capitalize on Internet technologies to simplify the way data is appropriated for display on a television for interactive services and leverage the Web designer community.

In the art of Internet radio, software tools exist which allow users to create playlists and host streaming radio services from their own personal computers. The users create, in effect, free individualized Internet radio stations.

### BRIEF DESCRIPTION OF THE DRAWINGS

The present invention is pointed out with particularity in the appended claims. However, other features are described in the following detailed description in conjunction with the accompanying drawing in which:

FIG. 1 is a block diagram of an embodiment of a system for providing multiple interactive content programs associated with a televised live event; and

FIG. 2 is a flow chart of an embodiment of a method of providing multiple interactive content programs associated with the televised live event.

### DETAILED DESCRIPTION OF THE PREFERRED EMBODIMENTS

Disclosed herein are improved methods for creating interactive content for a broadcast program at the time of its broadcast, and making the interactive content available to viewers of the broadcast. Web-based interactive program development tools and a broadband connection facilitate construction of ITV content that is inserted as a data stream to accompany the video of the broadcast program. Each viewer of the broadcast program can choose to tune to an ITV content provider of his/her choice to augment the video.

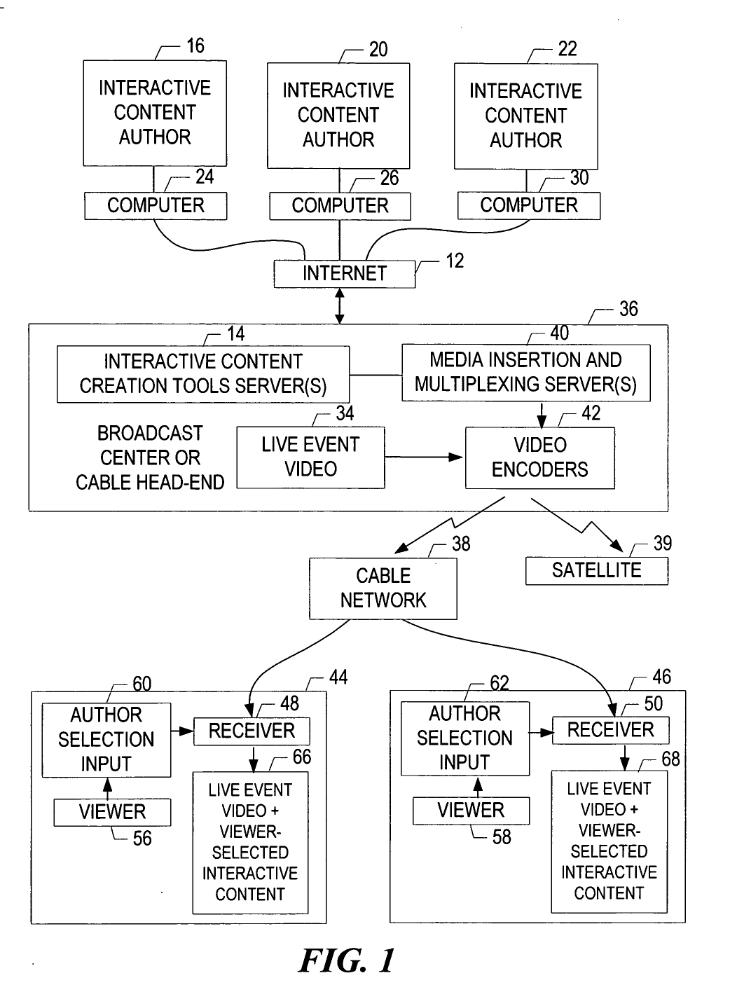

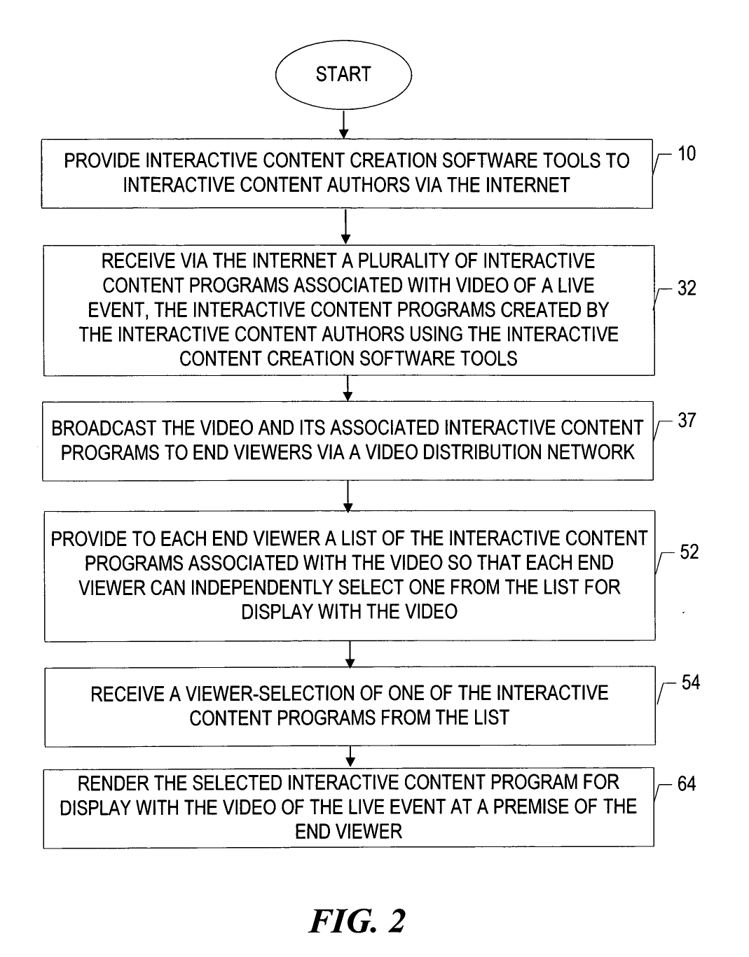

Embodiments of the present invention are described with reference to FIG. 1, which is a block diagram of an embodiment of a system for providing multiple interactive content programs associated with a televised event, and FIG. 2 which is a flow chart of an embodiment of a method of providing multiple interactive content programs associated with the televised event. In one embodiment, the televised event is a live event. Examples of the live event include, but are not limited to, a sporting event, a news program, a live concert, a live performance, a game show event, and video conferencing of a college class or another distance learning event.

As indicated by block 10, the method comprises providing interactive content creation software to prospective interactive content authors. The interactive content creation software may be provided via the Internet 12 by an interactive content creation tools server 14.

The software provides Web-based interactive program development tools to facilitate construction of ITV content that can accompany the broadcast of a live event. In one embodiment, the software contains numerous canned visual interfaces and related definitions for populating visual interfaces with dynamic content. A toolbox of options in the software enables the interactive content authors to quickly select from a range of visual styles and associated functionality.

The interactive content authors may be third parties, i.e. unassociated with a company creating and/or producing the televised live event and unassociated with a video distribution company that broadcasts the televised live event to its video service subscribers. In one embodiment, any individual having broadband Internet access, e.g. Digital Subscriber Line (DSL) or cable modem access, can qualify as an interactive content author if he/she desires to create interactive content associated with the televised live event.

For purposes of illustration and example, three interactive content authors 16, 20 and 22 are depicted in FIG. 1, although those having ordinary skill will recognize that the scope of this disclosure contemplates any number of interactive content authors. Each of the interactive content authors 16, 20 and 22 has an associated computer 24, 26 and 30 in communication with the Internet 12 to receive and run the interactive content creation software. The computers 24, 26 and 30 are remotely located from the server 14.

As indicated by block 32, the method comprises receiving via the Internet 12 a plurality of interactive content programs associated with video 34 of the live event. The interactive content programs are created by the interactive content authors 16, 20 and 22 using the interactive content creation software tools running on their computers 24, 26 and 30. The interactive content programs are received at a video distribution center 36 from the computers 24, 26 and 30 in the form of interactive television data streams. Examples of the video distribution center 36 include, but are not limited to, a cable television head-end, a satellite distribution center, and other video broadcast centers. The video distribution center 36 is responsible for terminating ITV inserts from third-party authors in real time, and providing the ITV content to subscribed viewers.

As indicated by block 37, the method comprises broadcasting the video 34 and the interactive content programs associated therewith from the video distribution center 36 to a plurality of end viewers via a video distribution network. The video distribution center 36 may broadcast multiple interactive content data streams for a particular piece of video content, or may use a 1-to-n multicast architecture to broadcast the interactive content programs.

Examples of the video distribution network include, but are not limited to, a cable television plant 38 and a satellite distribution network 39. For purposes of illustration and example, the cable television plant 38 will serve as the video distribution network in the described embodiment. However, in the case of using the satellite distribution network 39, the video distribution center 36 uplinks the video 34 and it's associated interactive content programs to a satellite using an assigned uplink frequency. The satellite, in turn, broadcasts the video 34 and its associated interactive content programs to subscribers of a satellite service.

The video distribution center 36 can receive the video 34 from various sources including but not limited to a satellite receiver and one or more telecommunications trunks that back-haul video signals.

The video distribution center 36 comprises a media insertion and multiplexing server 40 to multiplex the interactive content programs for insertion into a broadcast stream of the video 34. The video distribution center 36 further comprises a video encoder 42 to assemble a broadcast stream based on the video 34 and its associated interactive content programs into a particular format for broadcast. The broadcast stream may comprise a video stream and one or more data streams received from the computers 16, 20 and 22.

In one embodiment, the video encoder 42 comprises an MPEG-4 encoder to encode the video stream and the data streams into an MPEG-4 stream. The MPEG-4 specification utilizes the Apple™ file format and allows multiple streams of data to be associated with one media object. Each author's interactive content can be encoded within a corresponding data stream associated with the video 34. Thus, the act of broadcasting may comprise broadcasting multiple separate interactive programming data streams, each comprising a corresponding one of the interactive content programs, in addition to the video stream using MPEG-4.

The MPEG-4 streams are transmitted over the cable television plant 38 to households served by the cable head-end. For purposes of illustration and example, two households 44 and 46 are depicted in FIG. 1.

In another embodiment, the video encoder 42 encodes the video stream and the data streams based on the Advanced Television Enhancement Forum (ATVEF) specification. In this case, the broadcast may be facilitated using either ATVEF binding to Internet Protocol (IP) Multicast or ATVEF binding to National Television Standards Committee (NTSC).

In a further embodiment, the act of broadcasting comprises broadcasting the various interactive content programs associated with the video 34 within a vertical blanking interval of the video 34. In this embodiment, the interactive content programs associated with the video 34 are multiplexed for insertion in the vertical blanking interval.

The act of broadcasting may comprise sending data to accompany a packet of interactive program content to identify its author. The data may comprise one or more control bytes, for example.

Within the households 44 and 46 are receivers 48 and 50, respectively, capable of supporting an interactive television service. Each of the ITV-capable receivers 48 and 50 may be embodied by either a set top box for use with a television or a monitor, a personal computer having a display, or a television or a monitor having an integrated ITV-capable receiver. The ITV-capable receivers 48 and 50 are to extract the video 34 and viewer-selected interactive content from the broadcast. If the video 34 is encoded in MPEG-4, each of the receivers 48 and 50 comprises an MPEG-4 decoder to decode the video stream and one or more data streams. The ITV-capable receivers 48 and 50 include standard or custom ITV middleware to format and present viewer-selected interactive content in combination with the video on a display screen. Examples of the display screen include but are not limited to a television and a monitor.

To support the video 34 of the live event, some content authors may preselect one or more modules provided by the interactive content creation software to be transmitted as a data stream up front in an interactive broadcast. Thereafter, content authors can retrieve and assemble the dynamic content he/she would like to present for insertion into a data stream. Once transmitted, he/she may invoke a trigger to activate the module and associated content for display on the viewer's display screen.

As indicated by block 52, the method comprises providing to each of the end viewers a list of the interactive content programs associated with the video 34 so that each end viewer can independently select one of the interactive content programs from the list to augment the display of the video 34. If the broadcast includes multiple data streams associated with multiple interactive content programs, the broadcast may comprise an initial bootstrap interactive television application which contains computer program code to present the list to the end viewer and enable the end viewer to select one of the interactive content sources.

As indicated by block 54, the method comprises receiving a selection, made by an end viewer, of one of the interactive content programs from the list. Consider an end viewer 56 of the household 44 and an end viewer 58 of the household 46, each wishing to watch the video 34 of the live event, but wanting different interactive content to augment the video 34. The end viewer 56 generates a selection input 60 to the receiver 48 to select the interactive content program created by the interactive content author 20. The end viewer 58 generates a selection input 62 to the receiver 50 to select the interactive content program created by the interactive content author 16. The selection inputs 60 and 62 can be generated by a myriad of input devices associated with the receivers 60 and 62, examples of which include but are not limited to a remote control, one or more buttons or keys on a set-top box, and keyboard, a mouse or another pointing device of a personal computer.

As indicated by block 64, the method comprises rendering the selected interactive content program for display with the video 34 of the live event at the premise of the end viewer. Continuing with the above example, the receiver 48 decodes the video stream and the data stream generated by the computer 26, and renders a display 66 comprising the live event video augmented by the interactive content created by the interactive content author 20. The receiver 50 decodes the video stream and the data stream generated by the computer 24, and renders a display 68 comprising the live event video augmented by the interactive content created by the interactive content author 16.

The MPEG-4 standard describes a synchronization layer which facilitates identification of the types of content in various streams. Thus, one approach to letting a viewer select from multiple authors is to use the synchronization layer to identify all of the interactive programming data streams accompanying the video 34. Once identified, the selection list can be created by the viewer's ITV-capable receiver and presented by the display screen to the end viewer. Once the end viewer selects an author, the ITV-capable receiver would render only the data stream associated with the selected author and disregard the other data streams accompanying the video 34.

In another embodiment, the act of providing the list in block 52 may comprise occasionally broadcasting the list in at least one packet from the video distribution center 36. The at least one packet may be preceded by one or more unique control bytes to identify same as the list. Logic running on the ITV-capable receiver detects the list-identifying control byte to determine whether to process and use the at least one packet to generate a selection list for the end viewer. Further logic running on the ITV-capable receiver detects the author-identifying control byte to determine whether to process and use the accompanying content in association with the video 34 based on which author the end viewer has selected from the selection list.

To illustrate a practical application of the technology, a viewer of a football game would have a choice of selecting which author or channel of interactive TV content to include while he/she watches the game.

It is noted that, in practice, the video distribution center 36 would use the teachings herein to provide multiple third-party interactive content programs for each of a plurality of videos. To simultaneously encode multiple videos and their associated interactive content, the video distribution center 36 would have multiple video encoders. By supporting multiple videos, each interactive content author can create his/her own unique specialty of interactive content using the interactive content creation software. Each author may be a person in the comfort of his/her home using his/her broadband Internet connection to create interactive content on-the-fly while watching a televised live event.

Those having ordinary skill will recognize that the herein-disclosed acts can be directed by computer-readable program code stored by a computer-readable medium such as a storage medium or a signal-bearing medium. Examples of the storage medium include, but are not limited to, a magnetic storage medium such as a hard disk or a floppy disk, an optical storage medium such as an optical disk (e.g. a CD or a DVD), or an electronic storage medium such as an electronic memory (e.g. a computer's internal memory or a removable memory such as a memory card). Examples of the signal-bearing medium include, but are not limited to, an optical medium, an electronic medium, and an electromagnetic medium. Similarly, the herein-disclosed interactive content creation software and interactive content can be embodied by computer-readable media having computer-readable data and/or program code stored thereon.

It will be apparent to those skilled in the art that the disclosed embodiments may be modified in numerous ways and may assume many embodiments other than the particular forms specifically set out and described herein. For example, the one or more data streams may be broadcast separately from the video stream, such as over a broadband connection to the end viewers, in alternative embodiments. Also, the system may be used in conjunction with an interactive two-way broadcast service. In the case of multiple interactive programming channels being available for an event to be viewed, once an end viewer views a selection list and selects his/her preferred distribution source, the specific distribution channel's data stream is transmitted to the viewer's ITV receiver using a data protocol such as TCP/IP (Transmission Control Protocol/Internet Protocol). Thus, the herein-described act of broadcasting may comprise broadcasting the interactive content programs using a TCP/IP transmission separate from the video.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. A method of providing interactive television, the method comprising:
providing interactive content creation software tools to a plurality of interactive content authors via the Internet;
receiving via the Internet a plurality of interactive content programs associated with video of a live event, the interactive content programs created by the interactive content authors using the interactive content creation software tools;
broadcasting the video of the live event and the interactive content programs associated therewith to a plurality of end viewers via a video distribution network; and
providing to each of the end viewers a list of the interactive content programs associated with the video of the live event so that each end viewer can independently select one of the interactive content programs from the list for display with the video of the live event.

2. The method of claim 1 further comprising:
receiving a selection, made by an end viewer, of one of the interactive content programs from the list; and
rendering the selected interactive content program for display with the video of the live event at a premise of the end viewer.

3. The method of claim 1 wherein said broadcasting comprises broadcasting a plurality of separate interactive programming data streams each comprising a corresponding one of interactive content programs.

4. The method of claim 3 further comprising:
using a synchronization layer to identify all of the interactive programming data streams accompanying the video.

5. The method of claim 1 wherein said broadcasting comprising broadcasting the interactive content programs within a vertical blanking interval of the video.

6. The method of claim 1 wherein said broadcasting comprises sending data to accompany a packet of interactive program content to identify its author.

7. The method of claim 6 wherein the data comprises a control byte.

8. The method of claim 1 wherein said providing the list comprises broadcasting the list in at least one packet preceded by one or more unique control bytes.

9. The method of claim 1 wherein said broadcasting comprises broadcasting the interactive content programs using a TCP/IP transmission separate from the video.

10. A system for providing interactive television, the system comprising:
a video distribution center to provide interactive content creation software tools to a plurality of interactive content authors via the Internet, to receive via the Internet a plurality of interactive content programs associated with video of a live event and created by the interactive content authors using the interactive content creation software tools, to broadcast the video of the live event and the interactive content programs associated therewith to a plurality of end viewers via a video distribution network, and to provide to each of the end viewers a list of the interactive content programs associated with the video of the live event so that each end viewer can independently select one of the interactive content programs from the list for display with the video of the live event.

11. The system of claim 10 further comprising:
an interactive television receiver at the premise of an end viewer to receive a selection of one of the interactive content programs from the list, and to render the selected interactive content program for display with the video of the live event for the end viewer.

12. The system of claim 10 wherein the video distribution center is to broadcast a plurality of separate interactive programming data streams each comprising a corresponding one of interactive content programs.

13. The system of claim 12 wherein the video distribution center is to identify all of the interactive programming data streams accompanying the video using a synchronization layer.

14. The system of claim 10 wherein the video distribution center is to broadcast the interactive content programs within a vertical blanking interval of the video.

15. The system of claim 10 wherein the video distribution center is to send data to accompany a packet of interactive program content to identify its author.

16. The system of claim 15 wherein the data comprises a control byte.

17. The system of claim 10 wherein the video distribution center is to provide the list by broadcasting the list in at least one packet preceded by one or more unique control bytes.

18. The system of claim 10 wherein the video distribution center is to broadcast the interactive content programs using a TCP/IP transmission separate from the video.

19. The system of claim 10 further comprising a personal computer at the premise of an end viewer to receive a selection of one of the interactive content programs from the list, and to receive the selected interactive content program.
